(19) United States
(12) Patent Application Publication
(10) Pub. No.: US 2023/0018462 A1
(43) Pub. Date: Jan. 19, 2023

(54) INFORMATION PROCESSING APPARATUS, NON-TRANSITORY COMPUTER READABLE MEDIUM, INFORMATION PROCESSING METHOD

(71) Applicant: FUJIFILM Business Innovation Corp., Tokyo (JP)

(72) Inventor: Takashi MOMMA, Kanagawa (JP)

(73) Assignee: FUJIFILM Business Innovation Corp., Tokyo (JP)

(21) Appl. No.: 17/542,471

(22) Filed: Dec. 5, 2021

(30) Foreign Application Priority Data
Jul. 14, 2021 (JP) 2021-116594

(51) Int. Cl. G06F 21/55

(52) U.S. Cl. CPC G06F 21/554; G06F 2221/034; G06F 2221/2135

(57) ABSTRACT

An information processing apparatus includes a processor configured to: receive, from each of plural information devices, operation information indicating an operation that has been performed on the information device, the operation information being associated with event information indicating an event caused by the operation in the information device, and accumulate the operation information in an operation log database; and refer to the operation log database and, if different operations associated with a same event have been performed on at least a part of the plural information devices and, among the at least a part of the plural information devices, at least one information device fewer than or equal to a threshold value has been subjected to a minority operation, which is an operation different from an operation performed on other information devices, issue a warning against the minority operation.

### CROSS-REFERENCE TO RELATED APPLICATIONS

This application is based on and claims priority under 35 USC 119 from Japanese Patent Application No. 2021-116594 filed Jul. 14, 2021.

### BACKGROUND

### (i) Technical Field

The present disclosure relates to an information processing apparatus, a non-transitory computer readable medium, and an information processing method.

### (ii) Related Art

Information processing apparatuses that manage events caused in plural information devices have been proposed.

Japanese Unexamined Patent Application Publication No. 2016-170658, for example, discloses a process in which each of information devices transmits information regarding an event caused therein to a security management server and the security management server determines, on the basis of the information from each of the information devices, whether a predefined event has been caused in plural information devices. Japanese Unexamined Patent Application Publication No. 2013-30062 discloses an operation management assist apparatus capable of displaying a list of events caused in plural information devices to be managed.

### SUMMARY

Risky operations are sometimes performed in order to cause certain events in information devices. A “risky operation” herein refers to an operation that can inflict damage on an information device or a system including the information device. Examples of a risky operation include a secret special operation for obtaining authority about firmware update and a login operation using an operation unit provided for an information device without using a password when firmware of the information device is to be updated.

When a malicious person performs a risky operation, an information device or a system including the information device might sustain damage. Risky operations, therefore, are defined in advance, and a warning is issued if one of the predefined risky operations is performed on an information device.

Depending on an installation environment of an information device, a risky operation might be deliberately performed in order to cause a certain event. In the case of a building owned by a company where entry and exit of visitors are thoroughly monitored, for example, outsiders seldom enter the building, and risky operations might be performed on a daily basis.

In this case, a warning issued after a risky operation is performed is undesirably an incorrect warning (i.e., a warning without presence of a genuine risk). If an operation that poses a genuine risk is performed in an installation environment of an information device, on the other hand, a warning needs to be issued appropriately.

Aspects of non-limiting embodiments of the present disclosure relate to reduction in the number of incorrect warnings against operations performed on information devices compared to when risky operations are defined in advance and a warning is invariably issued after one of the predefined risk operations is performed on one of the information devices.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: receive, from each of a plurality of information devices, operation information indicating an operation that has been performed on the information device, the operation information being associated with event information indicating an event caused by the operation in the information device, and accumulate the operation information in an operation log database; and refer to the operation log database and, if different operations associated with a same event have been performed on at least some of the plurality of information devices and at least one of the at least some of the plurality of information devices fewer than or equal to a threshold value has been subjected to a minority operation, which is an operation different from an operation performed on others of the at least some of the plurality of information devices, issue a warning against the minority operation.

### BRIEF DESCRIPTION OF THE DRAWINGS

An exemplary embodiment of the present disclosure will be described in detail based on the following figures, wherein:

FIG. 1 is a schematic diagram illustrating the configuration of an information processing system according to an exemplary embodiment;

FIG. 2 is a schematic diagram illustrating the configuration of information devices;

FIG. 3 is a schematic diagram illustrating the configuration of a device management server;

FIG. 4 is a conceptual diagram illustrating an example of information stored in a device database;

FIG. 5 is a conceptual diagram illustrating an example of information stored in an operation database;

FIG. 6 is a conceptual diagram illustrating an example of information stored in an operation log database;

FIG. 7 is a conceptual diagram illustrating an example of information stored in a threshold value database; and

FIG. 8 is a flowchart illustrating a process performed by the device management server.

### DETAILED DESCRIPTION

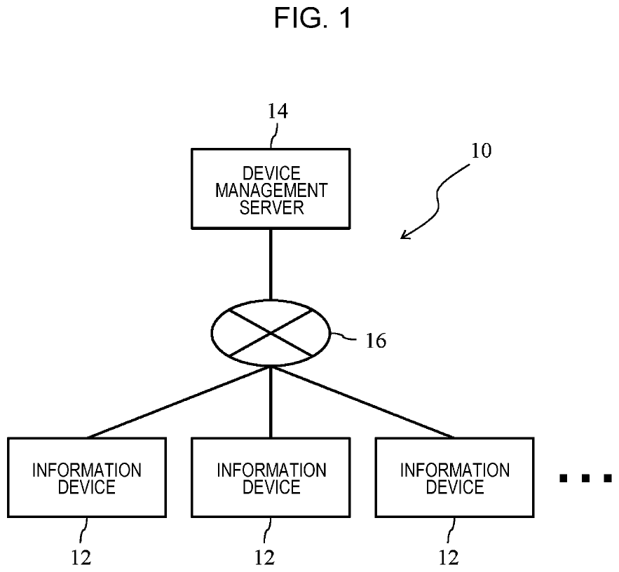

FIG. 1 is a schematic diagram illustrating the configuration of an information processing system 10 according to an exemplary embodiment. The information processing system 10 includes plural information devices 12 and a device management server 14 as an information processing apparatus. The information devices 12 and the device management server 14 are communicably connected to each other over a communication network 16 such as the Internet or a local area network (LAN).

The device management server 14 manages the information devices 12 included in the information processing system 10, that is, plural information devices 12 to be managed. More specifically, the device management server 14 monitors events caused, in the information devices 12 to be managed, by operations performed by users or other apparatuses and detects security risks posed by the events. This kind of management of security risks posed to information devices is called “security information and event management (SIEM)”. The information processing system 10 can thus be seen as an information device management system that manages the information devices 12.

If the device management server 14 determines that, in one of the information devices 12, an abnormal operation has been performed on the information device 12 or the information processing system 10, the device management server 14 issues a warning, details of which will be described later. An abnormal operation refers to an operation that is not expected by a manager of the information processing system 10, the information devices 12, or the device management server 14 (hereinafter simply referred to as a “manager”). An abnormal operation can be an operation that is likely to have been performed by a malicious third party with the intention of inflicting damage on the information processing system 10 or one of the information devices 12.

The information devices 12 managed by the device management server 14 are in similar installation environments (or use environments). For example, plural information devices 12 used in a single building or plural information devices 12 used by a single company are managed by the device management server 14.

Although not illustrated in FIG. 1, the information processing system 10 may also include a manager terminal, which is a computer used by the manager, a remote server that performs a process for updating firmware of the information devices 12, and/or the like.

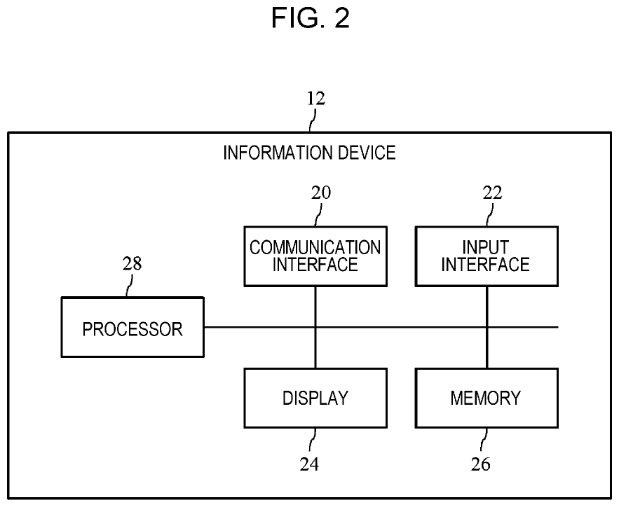

FIG. 2 is a schematic diagram illustrating the configuration of the information devices 12. In the present exemplary embodiment, the information devices 12 are image processing apparatuses (i.e., multifunction devices) having a printing function, a scanning function, a copying function, a facsimile function, and/or the like. The information devices 12, however, are not limited to image processing apparatuses and may be any devices that cause events as a result of operations performed by users or other apparatuses.

A communication interface 20 includes, for example, a network adapter. The communication interface 20 achieves a function of communicating with the device management server 14 and other apparatuses over the communication network 16. The communication interface 20 receives instructions from other apparatuses. For example, the communication interface 20 receives an instruction to update firmware from a remote server, an instruction to change settings from the manager terminal, and the like. The information device 12 causes events (e.g., firmware update, changes to settings, etc.) in accordance with these instructions. Operations performed on the information devices 12 herein include not only direct operations performed by the users on the information devices 12 but also transmission of such instructions from remote places (i.e., over the communication network 16).

An input interface 22 includes, for example, a touch panel or buttons. The input interface 22 receives an instruction to the information device 12 from a user by receiving an operation performed by the user. The user performs a certain operation using the input interface 22 to cause an event corresponding to the operation in the information device 12.

A display 24 includes, for example, a liquid crystal panel. The display 24 displays various screens.

A memory 26 includes, for example, a hard disk drive (HDD), a solid-state drive (SSD), an embedded MultiMediaCard (eMMC), a read-only memory (ROM), or a random-access memory (RAM). The memory 26 stores a device identifier (ID) for uniquely identifying the information device 12, firmware, which is software for operating the information device 12, setting information indicating settings of the information device 12, and the like.

A processor 28 refers to a processor in a broad sense. The processor 28 includes at least one of a general processor (e.g., a central processing unit (CPU)) or a dedicated processor (e.g., a graphics processing unit (GPU), an application-specific integrated circuit (ASIC), a field-programmable gate array (FPGA), or a programmable logic device). The processor 28 need not necessarily be a single processor, and may be plural processors that operate together from physically distant places. The processor 28 controls the other components of the information device 12.

Each of the information devices 12 may also include a printer that prints image data on a print medium such as sheets of paper, a scanner that reads paper documents to generate image data, or the like.

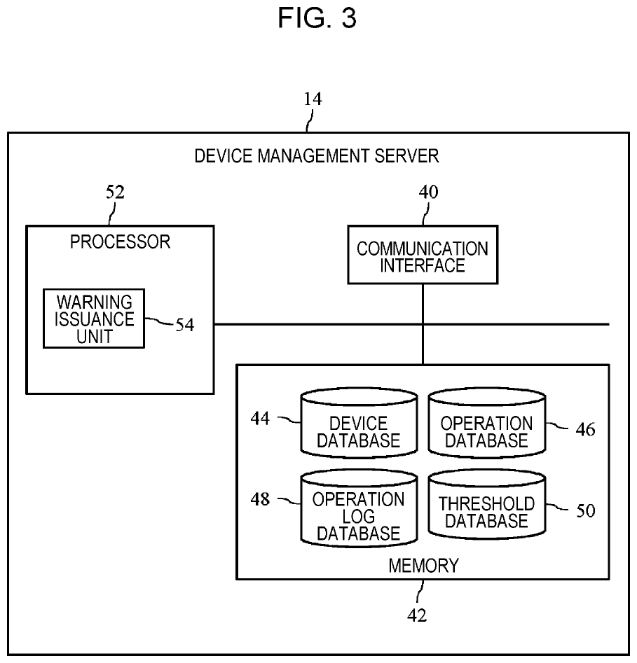

FIG. 3 is a schematic diagram illustrating the configuration of the device management server 14. The device management server 14 is achieved by, for example, a server computer. Alternatively, the device management server 14 may be achieved by plural computers. That is, functions of the device management server 14 achieved by the device management server 14, which will be described later, may be achieved by computers that operate together.

A communication interface 40 includes, for example, a network adapter. The communication interface 40 achieves a function of communicating with the information devices 12 over the communication network 16.

A memory 42 includes, for example, an HDD, an SSD, an eMMC, a ROM, or a RAM. The memory 42 stores a program for processing information, which is used to function the components of the device management server 14. As illustrated in FIG. 3, the memory 42 stores a device database 44, an operation database 46, an operation log database 48, and a threshold value database 50.

The device database 44 stores information regarding the information devices 12 managed by the device management server 14.

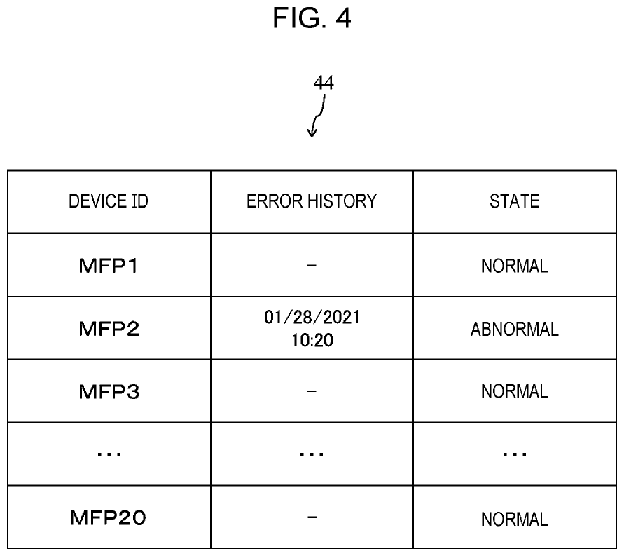

FIG. 4 is a conceptual diagram illustrating an example of the information stored in the device database 44. It is assumed in the present exemplary embodiment that the information processing system 10 includes twenty information devices 12 (i.e., the number of information devices 12 to be managed by the device management server 14 is 20). FIG. 4, therefore, illustrates information regarding the twenty information devices 12. In the device database 44, device IDs for uniquely identifying the corresponding information devices 12, error histories indicating errors that have occurred in the corresponding information devices 12, and state information indicating states of the corresponding information devices 12 are associated with one another.

An error history can be received from a corresponding information device 12. When an error occurs in one of the information devices 12 (here, an error that prevents the information device 12 from operating normally), for example, the information device 12 transmits an error notification to the device management server 14 along with a device ID thereof. A processor 52 (described later) of the device management server 14 stores, in the device database 44, a time at which the error notification has been received (i.e., an error occurrence time) while associating the time with the device ID received from the information device 12. The error history of each of the information device 12 may be manually input by the manager or the like to the device management server 14.

Examples of the state of each of the information devices 12 include a normal state, in which the information device 12 operates normally, and an abnormal state, in which the information device 12 does not operate normally. The processor 52 can determine the state of each of the information devices 12 on the basis of the error history of the information device 12. For example, the processor 52 may determine an information device 12 in which an error has occurred in past three days to be in the abnormal state, and the other information devices 12 to be in the normal state. The state of each of the information devices 12 may be manually input to the device management server 14 by the manager or the like.

In the operation database 46, operations performed on the information devices 12 to be managed and events caused in the information devices 12 as a result of the operations are associated with each other. The information stored in the operation database 46 is input by the manager or the like. In particular, the operation database 46 stores operations that cause events which can inflict damage on the information devices 12 or the information processing system 10. In the operation database 46, plural operations are associated with a single event caused thereby. That is, there are plural operations that cause a single event in each of the information devices 12. It is assumed in the present exemplary embodiment that the same operations cause the same events in all the information devices 12 to be managed.

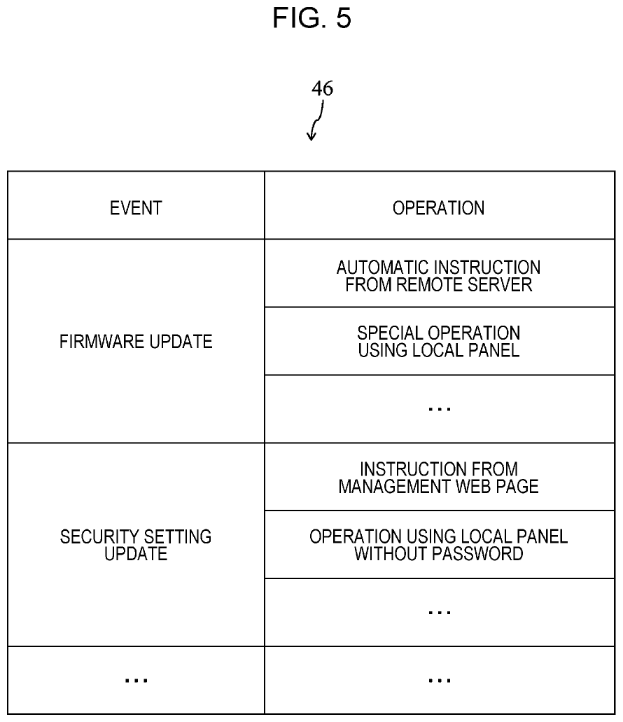

FIG. 5 is a conceptual diagram illustrating an example of information stored in the operation database 46. In the example illustrated in FIG. 5, firmware update and security setting update are stored as events. If a person other than the manager updates firmware of an information device 12 without permission, an error can suddenly occur in the information processing system 10. In addition, if a person other than the manager changes security settings without permission, an operation that might cause an error in the information processing system 10 can be performed on an information device 12. These events, therefore, are stored in the operation database 46.

In the example illustrated in FIG. 5, for example, an automatic instruction received from a remote server for updating firmware and a special operation performed by a user using a local panel (i.e., the input interface 22) of an information device 12 are stored as operations for updating firmware in each of the information devices 12. The special operation refers to an operation that is not basically disclosed to general users and that only the manager should know.

In the operation log database 48, operation information indicating operations performed on the information devices 12 to be managed and event information indicating events caused in the information devices 12 as a result of the operations are associated with each other.

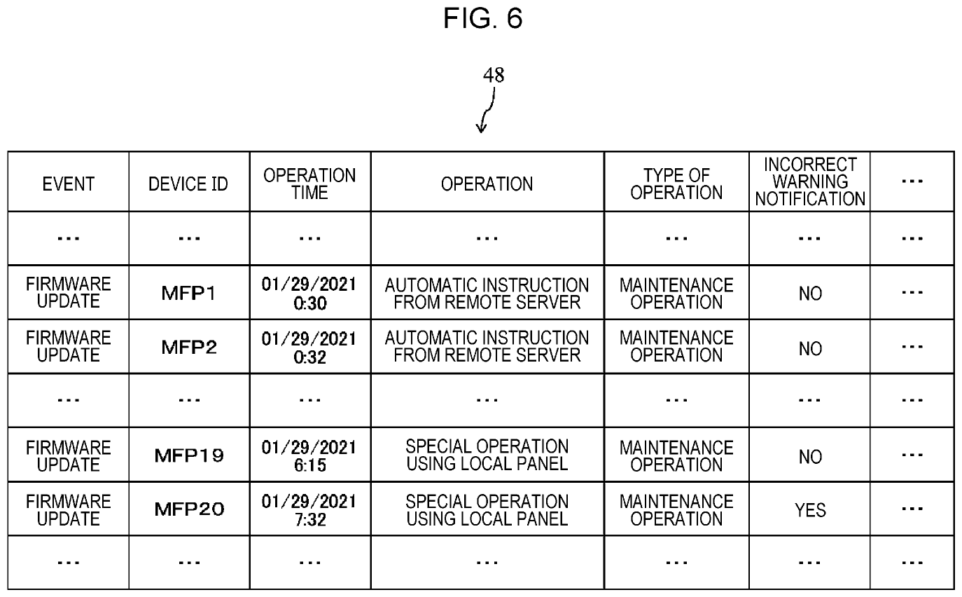

FIG. 6 is a conceptual diagram illustrating an example of information stored in the operation log database 48. In the operation log database 48, the device IDs of the information devices 12, operations performed on the information devices 12, times at which the operations have been performed on the information devices 12, and events caused by the operations in the information devices 12 are associated with one another.

Each time an operation is performed on each of the information devices 12 included in the information processing system 10, the information device 12 transmits, to the device management server 14, a device ID thereof and operation information indicating the operation. The processor 52 of the device management server 14 refers to the operation database 46 and identifies an event associated with the operation indicated by the operation information received from the information device 12. The processor 52 then accumulates, in the operation log database 48, the received device ID, a time at which the operation information has been received from the information device 12 (i.e., operation time), the operation, and the identified event while associating the device ID, the time, the operation, and the event with one another.

Although the device management server 14 receives operation information indicating an operation from one of the information devices 12 and the processor 52 refers to the operation database 46 and identifies an event associated with the operation in the present exemplary embodiment, each of the information devices 12 may transmit operation information including an operation and an event caused by the operation to the device management server 14, instead. In this case, the processor 52 stores the operation and the event included in the operation information in the operation log database 48 while associating the operation and the event with each other. In this case, the operation database 46 need not be prepared.

In the operation log database 48, a type of operation may be associated with each operation. More specifically, a type of operation is information indicating whether a corresponding operation is a maintenance operation, which is performed to maintain an information device 12. In the example illustrated in FIG. 5, for example, because the operations “automatic instruction from remote server” and “special operation using local panel”, which cause “firmware update”, are maintenance operations for an information device 12, a type of operation “maintenance operation” is associated with these operations. A type of operation associated with an operation may be included in operation information transmitted from an information device 12. That is, a type of operation corresponding to each operation is defined in advance in each of the information devices 12, and the information device 12 transmits, to the device management server 14, operation information including a device ID, an operation, and a type of operation corresponding to the operation. The processor 52 stores the operation and the type of operation included in the operation information in the operation log database 48 while associating the operation and the type of operation with each other. Alternatively, a type of operation may be associated with each operation or event in the operation database 46 (refer to FIG. 5), and the processor 52 may refer to the operation database 46 and identify a type of operation associated with an operation received from an information device 12.

Furthermore, in the operation log database 48, presence or absence of an incorrect warning notification may be associated with a combination of a device ID (i.e., an information device 12) and an operation. Details of presence or absence of an incorrect warning notification and a method for using the incorrect warning notification will be described later.

FIG. 6 illustrates operations that have caused firmware update in the twenty information devices 12 managed by the device management server 14. FIG. 6 does not illustrate operations performed on information devices 12 indicated by device IDs “MFP3” to “MFP18”, but it is assumed that, as with information devices 12 indicated by device IDs “MFP1” and “MFP2”, the operation “automatic instruction from remote server” and the event “firmware update” are associated with these information devices 12. It is needless to say that FIG. 6 illustrates only a part of the operation log database 48, and the operation log database 48 accumulates information regarding various operations performed on the information devices 12.

The memory 42 also stores the threshold value database 50, details of which will be described later.

The processor 52 refers to a processor in a broad sense. The processor 52 includes at least one of a general processor (e.g., a CPU) or a dedicated processor (e.g., a GPU, an ASIC, an FPGA, or a programmable logic device). The processor 52 need not necessarily be a single processor, and may be plural processors that operate together from physically distant places. The processor 52 achieves a function as a warning issuance unit 54 in accordance with the program for processing information stored in the memory 42.

The warning issuance unit 54 issues a warning if it is determined that an operation performed on one of the information devices 12 to be managed is an abnormal operation. Details of a process performed by the warning issuance unit 54 will be described hereinafter.

First, the warning issuance unit 54 refers to the operation log database 48 and extracts operations that have been performed on plural information devices 12 and that are associated with the same event. In the example illustrated in FIG. 6, for example, operations that have been performed on the twenty information devices 12 indicated by device IDs “MFP1” to “MFP20” and that are associated with the event “firmware update” are extracted. More specifically, the operation “automatic instruction from remote server”, which has been performed on eighteen information devices 12 indicated by the device IDs “MFP1” to “MFP18”, and the operation “special operation using local panel”, which has been performed on two information devices 12 indicated by the device IDs “MFP19” and “MFP20”, are extracted.

Next, the warning issuance unit 54 determines whether, among the information devices 12 subjected to the extracted operations (here, the twenty information devices 12 indicated by the device IDs “MFP1” to “MFP20”), information devices 12 fewer than or equal to a threshold value have been subjected to an operation different from one performed on the other information devices 12.

The manager or the like may determine the threshold value in advance. Alternatively, a percentage of information devices 12 subjected to an operation different from an operation performed on the other information devices 12 among the information devices 12 subjected to the extracted operations may be used as a threshold. In this case, the “information devices 12 fewer than or equal to a threshold value” refer to information devices 12 fewer than or equal to the percentage among the information devices 12 subjected to the extracted operations. The manager or the like may determine such a threshold percentage in advance. For example, a threshold percentage may be determined as 10% in advance. It is assumed in the following description that the threshold value is 2.

In this example, among the twenty information devices 12 subjected to the extracted operations, the two information devices 12 indicated by the device IDs “MFP19” and “MFP20” have been subjected to the operation “special operation using local panel”, which is different from the operation performed on the other information devices 12 (the eighteen information devices 12 indicated by the device IDs “MFP1” to “MFP18”). The warning issuance unit 54, therefore, determines that, among the information devices 12 subjected to the extracted operations, information devices 12 fewer than or equal to the threshold value, namely 2, have been subjected to an operation (this kind of operation will be referred to as a “minority operation” hereinafter) different from one performed on the other information devices 12.

If a minority operation has been performed on some of plural information devices 12, the warning issuance unit 54 determines that the minority operation is an abnormal operation. The warning issuance unit 54 then issues a warning against the minority operation. For example, the warning issuance unit 54 notifies, as a warning, the manager terminal used by the manager that the minority operation has been performed on the information devices 12 while transmitting device IDs of the information devices 12 subjected to the minority operation. Alternatively, the warning issuance unit 54 displays, as a warning, a warning message on displays 24 of the information devices 12 subjected to the minority operation.

When plural information devices 12 are in similar installation environments (or use environments), the same operation is likely to cause the same event in the information devices 12. In a case where firmware of information devices 12 installed in a certain company needs to be updated, for example, it is likely that a remote server will transmit an automatic instruction to every one of the information devices 12.

Depending on installation environments, a risky operation might be selected as an operation to be performed on plural information devices 12 in order to cause a certain event in the information devices 12. In this case, the risky operation will be deliberately performed on the information devices 12 in the installation environments. If risky operations are defined in advance and a warning is invariably issued after one of the predefined risky operations is performed on one of the information devices 12, a warning issued against a risky operation deliberately performed on an information device 12 is undesirably an incorrect warning.

In view of these circumstances, the warning issuance unit 54 in the present exemplary embodiment issues a warning only if a minority of information devices 12 (i.e., fewer than or equal to a threshold value) have been subjected to, as an operation for causing the same event in plural information devices 12 to be managed, an operation (i.e., a minority operation) different from one performed on other majority information devices 12.

As a result, even if a risky operation is deliberately performed on plural information devices 12 in order to cause a certain event in certain installation environments, the warning issuance unit 54 does not issue a warning insofar as the risky operation is performed on a majority of information devices 12. That is, incorrect warnings are reduced. If there is an operation performed on a minority of information devices 12 in order to cause a certain event, on the other hand, the operation is likely to be an abnormal operation and inflict damage on the information devices 12 or an information processing system 10 including the information device 12. The warning issuance unit 54, therefore, issues a warning.

Although a threshold value or a threshold percentage used by the warning issuance unit 54 to determine whether to issue a warning remains the same regardless of an operation in the present exemplary embodiment, different threshold values or threshold percentages may be used for different operations, instead. The threshold value database 50 stored in the memory 42 will be described hereinafter.

The threshold value database 50 stores different threshold values or threshold percentages for plural operations that can be performed on the information devices 12. The threshold values or the threshold percentages are a concept corresponding operation-dependent threshold values. In the threshold value database 50 in the present exemplary embodiment, different threshold values or threshold percentages are associated with plural operations that are stored in the operation database 46 and that cause a single event. A threshold value or a threshold percentage for each of the operations is determined in advance by the manager or the like and stored in the threshold value database 50.

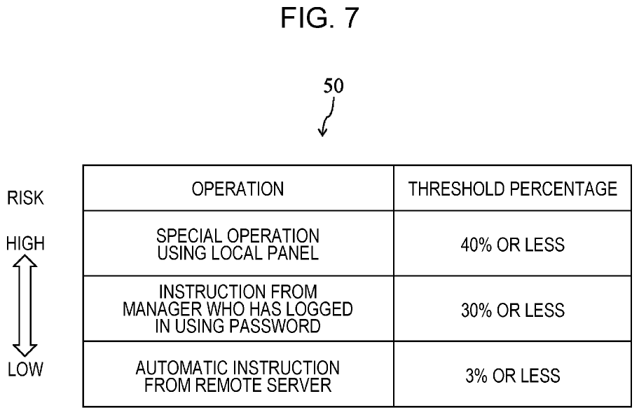

FIG. 7 is a conceptual diagram illustrating information stored in the threshold value database 50. In an example illustrated in FIG. 7, different threshold percentages are associated with plural operations “special operation using local panel”, “instruction from manager who has logged in using password”, and “automatic instruction from remote server” that cause the event “firmware update”. An example where threshold percentages are associated with operations will be described hereinafter, but threshold values may be associated with operations, instead, as described above.

In the threshold value database 50, higher threshold percentages are associated with operations with higher risks (i.e., a higher possibility of inflicting damage on an information device 12 or the information processing system 10 or greater damage inflicted on an information device 12 or the information processing system 10). In the example illustrated in FIG. 7, a risk of “special operation using local panel” is the highest among the three operations. A highest threshold percentage “40% or less”, therefore, is associated with the operation. A risk of “automatic instruction from remote server”, on the other hand, is the lowest among the three operations. A lowest threshold percentage “3% or less”, therefore, is associated with the operation. It is to be noted that an expression “X % or less” for a threshold percentage in FIG. 7 does not include “0%”, that is, a case where there is no applicable information device.

A process performed by the warning issuance unit 54 while referring to the threshold value database 50 is as follows. First, the warning issuance unit 54 refers to the operation log database 48 as in the above exemplary embodiment and extracts operations that have been performed on plural information device 12 and that are associated with the same event. In FIG. 6, for example, the warning issuance unit 54 extracts operations that have been performed on the twenty information devices 12 indicated by the device IDs “MFP1” to “MFP20” and that are associated with the event “firmware update”.

Next, the warning issuance unit 54 refers to the threshold value database 50 and determines whether each of the extracted operations has been performed on information devices 12 fewer than or equal to a threshold percentage associated with the operation in the threshold value database 50.

For example, first, since the threshold percentage “3% or less” is associated with the operation “automatic instruction from remote server” in the threshold value database 50, the warning issuance unit 54 determines whether the operation “automatic instruction from remote server” has been performed on less than or equal to 3% (interpreted as one information device 12 here) of the twenty information devices 12. Since the operation “automatic instruction from remote server” has been performed on eighteen information devices 12, the warning issuance unit 54 determines that the operation “automatic instruction from remote server” is not a minority operation, and does not issue a warning against the operation.

Next, since the operation “special operation using local panel” is associated with the threshold percentage “40% or less” in the threshold value database 50, the warning issuance unit 54 determines whether the operation “special operation using local panel” has been performed on less than or equal to 40% (eight information devices 12 or fewer) of the twenty information devices 12. Since the operation “special operation using local panel” has been performed on two information devices 12, the warning issuance unit 54 determines that the operation “special operation using local panel” is a minority operation, and issues a warning against the operation.

Since operations with higher risks are associated with higher threshold percentages in the threshold value database 50, a warning is more likely to be issued for operations with higher risks. The warning issuance unit 54 thus issues a warning in consideration of a risk of an operation.

An operation that is not usually performed might be performed on an information device 12 in an abnormal state in order to repair the information device 12. Even if an operation determined to be a minority operation has been performed on an information device 12 in an abnormal state, therefore, a warning issued for the operation tends to be an incorrect warning. The warning issuance unit 54, therefore, may keep from issuing a warning when a minority operation has been performed on an information device 12 in an abnormal state.

More specifically, the warning issuance unit 54 identifies, among plural information device 12, an information device 12 subjected to a minority operation using the above-described method. The warning issuance unit 54 then refers to the device database 44 and determines, on the basis of state information regarding the identified information device 12, whether the information device 12 is in an abnormal state. If the information device 12 is in an abnormal state, the warning issuance unit 54 does not issue a warning against a minority operation performed on the information device 12.

When a type of operation of a minority operation performed on an information device 12 in an abnormal state is not a maintenance operation for repairing the information device 12 but an attacking operation that causes “login failure” as an event, for example, a warning needs to be issued for such a minority operation.

If a minority operation has been performed on an information device 12 in an abnormal state, therefore, the warning issuance unit 54 refers to the operation log database 48 and identifies a type of operation of the minority operation performed on the information device 12. If the identified type of operation is other than “maintenance operation”, the warning issuance unit 54 may issue a warning against the minority operation performed on the information device 12. If the identified type of operation is “maintenance operation”, on the other hand, the warning issuance unit 54 need not issue a warning against the minority operation performed on the information device 12.

Even when the warning issuance unit 54 issues warnings using the above method, some incorrect warnings might be inevitable. There is a case, for example, where, among plural information devices 12 installed in the same company (i.e., plural information device 12 to be managed by the device management server 14), an information device 12 installed in a certain department is operated differently from the others. For example, an information device 12 installed in a department that handles confidential information might not be permitted to communicate with the outside, and firmware of the information device 12 might be updated not by an automatic instruction from a remote server but by a special operation using a local panel after the firmware is downloaded to the information device 12. In this case, the operation “special operation using local panel” performed on the information device 12 is not an operation intended to inflict damage on the information device 12 or an information processing system 10 including the information device 12, but because the operation is a minority operation, the warning issuance unit 54 undesirably issues a warning.

In this case, the manager notifies the device management server 14 that the warning is an incorrect warning. The warning issuance unit 54 then stores, on the basis of the notification from the manager, information indicating that there has been an incorrect warning notification in the operation log database 48 (refer to FIG. 6) while associating the information with a combination of a device ID of the information device 12 and the operation (minority operation) corresponding to the warning. In the example illustrated in FIG. 6, “incorrect warning notification” is “Yes” for a combination of the device ID “MFP20” and the operation “special operation using local panel”.

If there is an incorrect warning notification from the manager, a minority operation that corresponds to a warning for which the incorrect warning notification has been issued and that has been performed on an information device 12 relating to the warning is unlikely to be an operation that will inflict damage on the information device 12 or an information processing system 10 including the information device 12. When the warning issuance unit 54 is notified that an issued warning is an incorrect warning, therefore, the warning issuance unit 54 may keep from issuing a warning even if the minority operation relating to the warning is performed on the information device 12 relating to the warning thereafter.

More specifically, the warning issuance unit 54 identifies, among plural information devices 12, an information device 12 subjected to a minority operation using the above method. The warning issuance unit 54 then refers to the operation log database 48 again and determines whether “incorrect warning notification” associated with a combination of the identified information device 12 and the minority operation is “Yes”. If “incorrect warning notification” is “Yes”, the warning issuance unit 54 does not issue a warning against the minority operation performed on the information device 12.

In addition, an operation whose “incorrect warning notification” is “Yes” may also include other operations similar to the operation. In the example illustrated in FIG. 6, for example, an operation whose “incorrect warning notification” is “Yes” is “special operation using local panel” performed on the information device 12 indicated by the device ID “MFP20”, but the operation whose “incorrect warning notification” is “Yes” may also include a similar operation “operation using local panel” performed on the information device 12 indicated by the device ID “MFP20”. This is based on a fact that when it is found that a warning issued against a minority operation performed on an information device 12 is an incorrect warning, that is, when it is found that a minority operation performed on an information device 12 is not an operation that will inflict damage on the information device 12 or the information processing system 10, similar operations performed on the information device 12 are usually not operations that will inflict damage on the information device 12 or the information processing system 10. An event caused by an operation whose “incorrect warning notification” is “Yes” and an event caused by a similar operation may be the same or different from each other.

As a result, as illustrated in FIG. 6, if a similar operation “operation using local panel without password” that causes an event “security setting update” is performed on the information device 12 indicated by the device ID “MFP20” when “incorrect warning notification” of a combination of the device ID “MFP20” and the operation “special operation using local panel” is “Yes”, the warning issuance unit 54 may keep from issuing a warning even if the similar operation is a minority operation.

The case will be assumed again where a certain information device 12 among plural information devices 12 to be managed is operated differently from other information devices 12 for maintenance purposes. Even when a notification indicating that an issued warning is an incorrect warning is received and then a minority operation relating to the warning is performed on the information device 12 in this situation, a warning is desirably issued against the minority operation if a type of operation of the minority operation is not a maintenance operation but, for example, an attacking operation that causes the event “login failure”.

If “incorrect warning notification” of a combination of an identified information device 12 and a minority operation is “Yes”, therefore, the warning issuance unit 54 further refers to the operation log database 48 and identifies a type of operation of the minority operation performed on the information device 12. If the identified type of operation is other than “maintenance operation”, the warning issuance unit 54 may issue a warning against the minority operation performed on the information device 12. If the identified type of operation is “maintenance operation”, on the other hand, the warning issuance unit 54 may keep from issuing a warning against the minority operation performed on the information device 12.

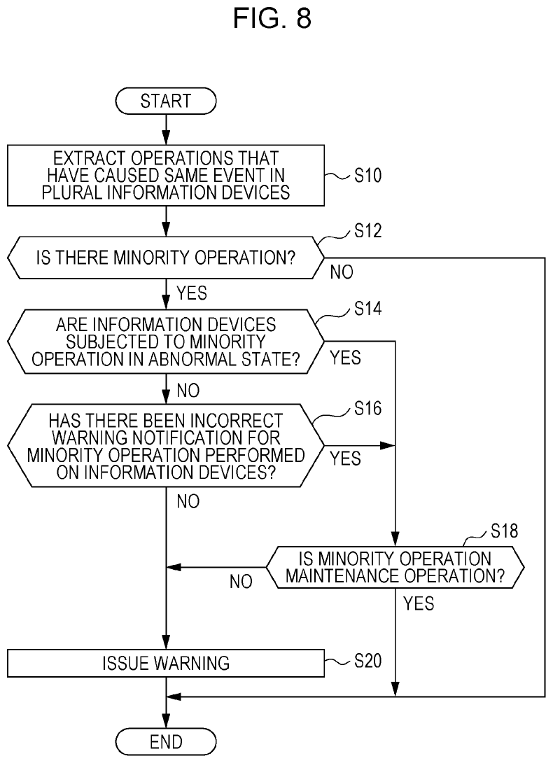

An outline of the information processing system 10 according to the present exemplary embodiment is as described above. A process performed by the device management server 14 will be described hereinafter with reference to a flowchart of FIG. 8.

In step S10, the warning issuance unit 54 refers to the operation log database 48 and extracts operations that have been performed on plural information devices 12 and that are associated with the same event.

In step S12, the warning issuance unit 54 determines whether, among the information device 12 subjected to the operations extracted in step S10, information devices 12 fewer than or equal to a threshold value have been subjected to an operation different from one performed on the other information devices 12, that is, a minority operation. If a minority operation has not been performed, the process ends. If a minority operation has been performed, the process proceeds to step S14.

In step S14, the warning issuance unit 54 refers to the device database 44 and determines whether the information devices 12 subjected to the minority operation, the information devices 12 having been identified in step S12, are in an abnormal state. If the information devices 12 are not in an abnormal state, the process proceeds to step S16. If the information devices 12 are in an abnormal state, the process proceeds to step S18.

In step S16, the warning issuance unit 54 refers to the operation log database 48 and determines whether “incorrect warning notification” of combinations of the information devices 12 identified in step S12 and the minority operation is “Yes”. If “incorrect warning notification” of the combinations is “Yes”, the process proceeds to step S18. If “incorrect warning notification” of the combinations is “No”, the process proceeds to step S20.

In step S18, the warning issuance unit 54 refers to the operation log database 48 and determines whether a type of operation associated with the minority operation identified in step S12 is “maintenance operation”. If the type of operation is “maintenance operation”, the process proceeds to step S20. If the type of operation is “maintenance operation”, the process ends.

In step S20, the warning issuance unit 54 issues a warning against the minority operation performed on the information devices 12 identified in step S12.

Although an exemplary embodiment of the present disclosure has been described, the present disclosure is not limited to this exemplary embodiment. The above exemplary embodiment may be modified in various ways without deviating from the scope of the present disclosure.

Although the memory 42 of the device management server 14 stores the device database 44, the operation database 46, the operation log database 48, and the threshold value database 50 in the above exemplary embodiment, for example, these databases may be stored in a memory of another apparatus accessible from the device management server 14, instead.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive, from each of a plurality of information devices, operation information indicating an operation that has been performed on the information device, the operation information being associated with event information indicating an event caused by the operation in the information device, and accumulate the operation information in an operation log database; and
refer to the operation log database and, if different operations associated with a same event have been performed on at least a part of the plurality of information devices and at least one of the at least some of the plurality of information devices fewer than or equal to a threshold value has been subjected to a minority operation, which is an operation different from an operation performed on others of the at least some of the plurality of information devices, issue a warning against the minority operation.

2. The information processing apparatus according to claim 1,
wherein the at least one of the at least some of the plurality of information devices fewer than or equal to the threshold value is at least one of the at least some of the plurality of information devices fewer than or equal to a threshold percentage.

3. The information processing apparatus according to claim 1,
wherein the processor is configured to:
refer to a threshold value database in which an operation-dependent threshold value, which is a threshold value different between operations, is associated with each of the operations; and
issue the warning if different operations associated with a same event have been performed on at least some of the plurality of information devices and at least one of the at least some of the plurality of information devices fewer than or equal to one of the operation-dependent threshold values have been subjected to an operation associated with the operation-dependent threshold value.

4. The information processing apparatus according to claim 2,
wherein the processor is configured to:
refer to a threshold value database in which an operation-dependent threshold value, which is a threshold value different between operations, is associated with each of the operations; and
issue the warning if different operations associated with a same event have been performed on at least some of the plurality of information devices and at least one of the at least some of the plurality of information devices fewer than or equal to one of the operation-dependent threshold values have been subjected to an operation associated with the operation-dependent threshold value.

5. The information processing apparatus according to claim 1,
wherein the processor is configured to:
determine, on a basis of state information indicating a state of each of the plurality of information devices, whether the information device is in an abnormal state; and
keep from issuing the warning if the minority operation is performed on an information device in the abnormal state.

6. The information processing apparatus according to claim 5,
wherein the operation information accumulated in the operation log database is also associated with information indicating whether the operation indicated by the operation information is a maintenance operation for maintaining a corresponding one of the plurality of information devices, and
wherein the processor is configured to keep from issuing the warning if the minority operation is performed on one of the plurality of information devices in the abnormal state and the minority operation is the maintenance operation.

7. The information processing apparatus according to claim 1,
wherein the processor is configured to keep, if a notification indicating that the issued warning is an incorrect warning is received, from issuing the warning thereafter even if the minority operation relating to the warning is performed on one of the at least one information device relating to the warning.

8. The information processing apparatus according to claim 7,
wherein the operation information accumulated in the operation log database is also associated with information indicating whether the operation indicated by the operation information is a maintenance operation for maintaining a corresponding one of the plurality of information devices,
wherein the processor is configured to keep, if a notification indicating that the issued warning is an incorrect warning, from issuing the warning thereafter even if the minority operation relating to the warning is performed on one of the at least one information device relating to the warning and the minority operation is the maintenance operation.

9. A non-transitory computer readable medium storing a program causing a computer to execute a process for processing information, the process comprising:
receiving, from each of a plurality of information devices, an operation that has been performed on the information device and that is associated with event information indicating an event caused by the operation in the information device and accumulating the operation in an operation log database; and
referring to the operation log database and, if different operations associated with a same event have been performed on at least some of the plurality of information devices and at least one of the at least some of the plurality of information devices fewer than or equal to a threshold value has been subjected to a minority operation, which is an operation different from an operation performed on others of the at least some of the plurality of information devices, issuing a warning against the minority operation.

10. An information processing method comprising:
receiving, from each of a plurality of information devices, an operation that has been performed on the information device and that is associated with event information indicating an event caused by the operation in the information device and accumulating the operation in an operation log database; and
referring to the operation log database and, if different operations associated with a same event have been performed on at least some of the plurality of information devices and at least one of the at least some of the plurality of information devices fewer than or equal to a threshold value has been subjected to a minority operation, which is an operation different from an operation performed on others of the at least some of the plurality of information devices, issuing a warning against the minority operation.
